(19) United States
(12) Patent Application Publication
(10) Pub. No.: US 2011/0214383 A1
(43) Pub. Date: Sep. 8, 2011

(54) Versatile Laboratory Protective Apparatus

(76) Inventor: Kambiz Yaraei, Edmonds, WA (US)

(21) Appl. No.: 12/759,914

(22) Filed: Apr. 14, 2010

Related U.S. Application Data
(60) Provisional application No. 61/309,959, filed on Mar. 3, 2010.

(51) Int. Cl. E04B 1/92; B01L 1/00

(52) U.S. Cl. 52/741.3

(57) ABSTRACT

A versatile laboratory protective apparatus including one or more transparent shields and one or more supporting members each independently attaching the one or more transparent shields to one or more pieces of furniture, one or more fixtures, or one or more walls, is provided. A method of using the versatile laboratory protective apparatus is also provided.

### RELATED APPLICATIONS

This application claims priority to U.S. Provisional Patent Application Ser. No. 61/309,959 filed Mar. 3, 2010, which is hereby incorporated by reference in its entirety for all purposes.

### BACKGROUND OF THE INVENTION

When handling blood, biological fluids, or chemicals, medical and research laboratory personnel are constantly threatened with exposure to toxic or life-threatening particles. This danger is especially high when these fluids are preserved in vacuum tubes, as is usually the case with blood samples. When opening vacuum tubes, the technician must exercise extreme caution since the sudden rush of air into the vacuum displaces infinitesimal amounts of fluid thereby propelling invisible fluid particles into the air and in some cases splashing of blood or biohazard materials in the technician's face. The subsequent mucosal contact (via eyes and nose), inhalation or ingestion of these particles or aerosols places the technician in peril of contracting contagious diseases such as hepatitis and AIDS.

Various apparatus have been used to reduce the risk of exposure, such as surgical masks, glasses and face shield. Such masks, glasses and face shield however, have proved to be costly and inadequate since they are uncomfortable to wear and require placement by the technician. Vacuum hoods are similarly undesirable since their size and weight render them unmovable. A technician must therefore interrupt their work in one area of the laboratory to seek the nearest vacuum hood before opening a container or handling toxic or life-threatening materials. These hoods are also expensive to purchase and costly to operate. Further, laboratory hoods perform only one function.

What is need is an inexpensive versatile laboratory protective apparatus that can perform multiple functions and not occupy a lot of laboratory space.

### SUMMARY OF THE INVENTION

The present invention provides a versatile laboratory protective apparatus that can be attached underneath wall cabinets, underneath a countertop in a laboratory, a wall, or any other fixture and can be deployed as needed. The versatile laboratory protective apparatus will not only save valuable laboratory space, but will act as (1) a shield to protect face and eyes from any splashing of materials, (2) a holder for posters, pictures, graphs or other materials for presentation in the laboratory, (3) a writing board, (4) a light source, (5) a ruler, (6) a magnifying lens, (7) a safe light filter, (8) a disinfection apparatus, (9) a calculator holder, (10) a holder for instrument gauges, for example, humidity and/or temperature, (11) a pen holder, or a combination thereof.

The versatile laboratory protective apparatus does not occupy any space on the laboratory countertop as current safety shields. The versatile laboratory protective apparatus is inexpensive to manufacture and easy to install. Further, important laboratory items, for example, lights, temperature and humidity gauges, calculators, pen holders, magnifying lenses, rulers, and the like can be attached to the protective apparatus and be within easy viewing distance of the laboratory worker. If a safe light environment is needed, the protective apparatus can be constructed with the appropriate safe light material to effective block damaging light from entering into and/or exiting from the work area. If disinfection of the work bench is required, an ultraviolet light may be included in the versatile laboratory protective apparatus.

The present invention provides a versatile laboratory protective apparatus. The versatile laboratory protective apparatus includes: one or more transparent shields each having an upper surface, a lower surface, a front edge, a back edge, a right-side edge, and a left-side edge; and one or more supporting members each independently attaching the one or more transparent shields to one or more pieces of furniture, one or more fixtures, or one or more walls, wherein the one or more transparent shields and the one or more supporting members are assembled in a manner such that the one or more transparent shields can be positioned down or positioned up from the one or more pieces of furniture, one or more fixtures, or one or more walls, and positioned between a user and a source of one or more bio-hazardous materials, chemicals, electromagnetic radiation, wood chips, metal chips, or combinations thereof.

In one embodiment, the one or more transparent shields each independently include one or more rigid shatter-resistant transparent sheet materials. In another embodiment, if more than one rigid shatter-resistant transparent sheet materials are present, then the more than one rigid shatter-resistant transparent sheet materials are laminated together. In yet another embodiment, the one or more transparent shields each independently includes one or more flexible shatter-resistant transparent sheet materials.

In one embodiment, the one or more flexible shatter-resistant transparent sheet materials is in the shape of a roll, wherein the roll is in a dispenser. In another embodiment, if more than one flexible shatter-resistant transparent sheet materials are present, then the more than one flexible shatter-resistant transparent sheet materials are laminated together. In yet another embodiment, the one or more transparent shields each independently includes a combination of one or more rigid shatter-resistant transparent sheet materials and one or more flexible shatter-resistant transparent sheet materials.

In one embodiment, the combination of one or more rigid shatter-resistant transparent sheet materials and one or more flexible shatter-resistant transparent sheet materials are laminated together. In another embodiment, the one or more transparent shields each independently includes polyacrylate, polymethacrylate, polycarbonate, polyolefin, ethylvinyl alcohol, polyester, co-polymerized polyester, polyamide, polyethylene terephthalate, polyurethane, polyethylene, polyvinylchloride film, polybutylene terephthalate, or combinations thereof. In yet another embodiment, the one or more transparent shields each independently further includes one or more lights, one or more rulers, one or more magnifying lens, one or more protractors, one or more calculators, one or more watches, one or more timers, one or more temperature gauges, one or more vacuum pumps, one or more humidity gauges, one or more trays, one or more writing surfaces, one or more writing pads, one or more paper holding devices, one or more poster holding devices, or a combination thereof.

In one embodiment, the one or more lights, one or more rulers, one or more magnifying lens, one or more protractors, one or more calculators, one or more watches, one or more timers, one or more temperature gauges, one or more vacuum pumps, one or more humidity gauges, one or more trays, one or more writing surfaces, one or more writing pads, one or more paper holding devices, one or more poster holding devices, or a combination thereof are located on the upper surface of the one or more transparent shields, the lower surface of the one or more transparent shields, the front edge of the one or more transparent shields, the back edge of the one or more transparent shields, the right-side edge of the one or more transparent shields, the left-side edge of the one or more transparent shields, or a combination thereof. In another embodiment, the one or more lights comprise one or more fluorescent lights, one or more ultra-violet lights, one or more infrared lights, or a combination thereof. In yet another embodiment, the one or more pieces of furniture, one or more fixtures, or one or more walls, includes a work bench having an upper surface and a lower surface, a cabinet having an upper surface and a lower surface, a shelf having an upper surface and a lower surface, a wall having an outer surface, a floor stand, a chair, a bed having an upper surface and a lower surface, a pipe, or a combination thereof.

In one embodiment, the one or more supporting members each independently attach the one or more transparent shields to the upper surface of the work bench. In another embodiment, the one or more supporting members each independently attach the one or more transparent shields to the lower surface of the work bench. In yet another embodiment, the one or more supporting members each independently attach the one or more transparent shields to the upper surface of the cabinet.

In one embodiment, the one or more supporting members each independently attach the one or more transparent shields to the lower surface of the cabinet. In another embodiment, the one or more supporting members each independently attach the one or more transparent shields to the upper surface of the shelf. In yet another embodiment, the one or more supporting members each independently attach the one or more transparent shields to the lower surface of the shelf.

In one embodiment, the one or more supporting members each independently attach the one or more transparent shields to the outer surface of the wall. In another embodiment, the one or more supporting members each independently attach the one or more transparent shields to the floor stand. In yet another embodiment, the one or more supporting members each independently attach the one or more transparent shields to the chair.

In one embodiment, the one or more supporting members each independently attach the one or more transparent shields to the lower surface of the bed. In another embodiment, the one or more supporting members each independently attach the one or more transparent shields to any surface using one or more clips, one or more pieces of Velcro, one or more flexible arms, or a combination thereof. In yet another embodiment, the one or more transparent shields each independently further includes one or more front shields, one or more left-side shields, one or more right side shields, or a combination thereof.

In one embodiment, the one or more front shields, the one or more left-side shields, the one or more right side shields, or a combination thereof, may each independently comprise one or more notches, one or more apertures, one or more protective gloves, or a combination thereof. In another embodiment, the one or more front shields each comprise a pair of notches on either side of the one or more front shields. In yet another embodiment, the pair of notches extends from about the base to midway up the one or more front shields.

In one embodiment, the one or more supporting members each comprise one or more drawer slide devices, one or more hinge devices, one or more adjustable arm devices, one or more hook-and-loop fastener devices, one or more cantilever devices, or combinations thereof. In another embodiment, the one or more drawer slide devices each comprise one or more side mount drawer slide devices, one or more center mount drawer slide devices, one or more under mount drawer slide devices, one or more European drawer slide devices, or a combination thereof. In yet another embodiment, the one or more drawer slide devices each comprise one or more wooden slide devices, one or more plastic slide devices, one or more ball bearing slide devices, one or more metal slide devices, or combinations thereof.

In one embodiment, the one or more hinge devices each comprise one or more barrel hinge devices, one or more pivot hinge devices, one or more butt and mortised hinge devices, one or more continuous hinge devices, one or more concealed hinge devices, one or more butterfly hinge devices, one or more strap hinge devices, one or more H hinge devices, one or more HL hinge devices, one or more counter flap hinge devices, one or more flush hinge devices, one or more coach hinge devices, one or more rising butt hinge devices, one or more double action spring hinge devices, one or more Tee hinge devices, one or more friction hinge devices, one or more security hinge devices, one or more cranked hinge devices, one or more lift-off hinge devices, one or more self-closing hinge devices, one or more butt hinge devices, or a combination thereof.

In one embodiment, the versatile laboratory protective apparatus further includes a notch into the right edge of the one or more transparent shields and a notch into the left edge of the one or more transparent shields to facilitate access to the source of the one or more bio-hazardous materials, chemicals, electromagnetic radiation, or combinations thereof. In another embodiment, the positioning of the one or more transparent shields is performed manually, by a machine, or a combination thereof.

In one embodiment, the one or more transparent shields each include one or more safe light filters.

The present invention provides a versatile laboratory protective apparatus. The versatile laboratory protective apparatus includes: one or more transparent shields each having an upper surface, a lower surface, a front edge, a back edge, a right-side edge, and a left-side edge, wherein the one or more transparent shields each independently includes one or more rigid shatter-resistant transparent sheet materials; and one or more supporting members each independently attaching the one or more transparent shields to one or more pieces of laboratory furniture, one or more laboratory fixtures, or one or more laboratory walls, wherein the one or more pieces of laboratory furniture, one or more laboratory fixtures, or one or more laboratory walls includes a work bench having an upper surface and a lower surface, a cabinet having an upper surface and a lower surface, a shelf having an upper surface and a lower surface, a wall having an outer surface, a floor stand, a chair, a bed, a pipe, or a combination thereof, and wherein the one or more transparent shields and the one or more supporting members are assembled in a manner that the one or more transparent shields can be positioned down or positioned up from the one or more pieces of laboratory furniture, one or more laboratory fixtures, or one or more laboratory walls and positioned between a user and a source of one or more bio-hazardous materials, chemicals, electromagnetic radiation, wood chips, metal chips, or combinations thereof.

The present invention provides a method of shielding personnel from one or more bio-hazardous materials, chemicals, electromagnetic radiation, or combinations thereof. The method includes: attaching a versatile laboratory protective apparatus to one or more pieces of furniture, one or more fixtures, or one or more walls, wherein the versatile laboratory protective apparatus includes; one or more transparent shields each having an upper surface, a lower surface, a front edge, a back edge, a right-side edge, and a left-side edge; and one or more supporting members each independently attaching the one or more transparent shields to one or more pieces of furniture, one or more fixtures, or one or more walls, wherein the one or more transparent shields and the one or more supporting members are assembled in a manner such that the one or more transparent shields can be positioned down or positioned up from the one or more pieces of furniture, one or more fixtures, or one or more walls, and positioned between a user and a source of one or more bio-hazardous materials, chemicals, electromagnetic radiation, or combinations thereof; positioning the one or more transparent shields between a user and a source of one or more bio-hazardous materials, chemicals, electromagnetic radiation, wood chips, metal chips, or combinations thereof; and working with the source of one or more bio-hazardous materials, chemicals, electromagnetic radiation, or combinations thereof.

The present invention provides a method of shielding laboratory personnel from one or more bio-hazardous materials, chemicals, electromagnetic radiation, or combinations thereof. The method includes: attaching a versatile laboratory protective apparatus to one or more pieces of laboratory furniture, one or more laboratory fixtures, or one or more laboratory walls, wherein the versatile laboratory protective apparatus includes; one or more transparent shields each having an upper surface, a lower surface, a front edge, a back edge, a right-side edge, and a left-side edge; and one or more supporting members each independently attaching the one or more transparent shields to the one or more pieces of laboratory furniture, one or more laboratory fixtures, or one or more laboratory walls, wherein the one or more transparent shields and the one or more supporting members are assembled in a manner such that the one or more transparent shields can be positioned down or positioned up from the one or more pieces of laboratory furniture, one or more laboratory fixtures, or one or more laboratory walls, and positioned between a user and a source of one or more bio-hazardous materials, chemicals, electromagnetic radiation, or combinations thereof; positioning the one or more transparent shields between a user and a source of one or more bio-hazardous materials, chemicals, electromagnetic radiation, wood chips, metal chips, or combinations thereof; and working with the source of one or more bio-hazardous materials, chemicals, electromagnetic radiation, or combinations thereof.

### BRIEF DESCRIPTION OF THE DRAWINGS

Embodiments of the invention may be best understood by referring to the following description and accompanying drawings, which illustrate such embodiments. In the drawings:

FIG. 1 is a perspective front-view drawing illustrating an exemplary laboratory protective apparatus retracted under a laboratory cabinet.

FIG. 2 is a perspective front-view drawing illustrating an exemplary laboratory protective apparatus in a partially extended position from under a laboratory cabinet.

FIG. 3 is a perspective front-view drawing illustrating an exemplary laboratory protective apparatus in fully extended position from under a laboratory cabinet.

FIG. 4 is a perspective front-view drawing illustrating an exemplary laboratory protective apparatus retracted under a laboratory cabinet.

FIG. 5 is a perspective front-view drawing illustrating an exemplary laboratory protective apparatus in a partially extended position from under a laboratory cabinet.

FIG. 6 is a perspective front-view drawing illustrating an exemplary laboratory protective apparatus in a partial full position from under a laboratory cabinet.

FIG. 7 is a perspective front-view drawing illustrating an exemplary laboratory protective apparatus in a full position from under a laboratory cabinet.

FIG. 8 is a perspective front-view drawing illustrating an exemplary laboratory protective apparatus retracted under a laboratory cabinet.

FIG. 9 is a perspective front-view drawing illustrating an exemplary laboratory protective apparatus in a full position from under a laboratory cabinet.

FIG. 10 is a perspective front-view drawing illustrating an exemplary laboratory protective apparatus retracted under a laboratory table.

FIG. 11 is a perspective front-view drawing illustrating an exemplary laboratory protective apparatus in an extended position from under a laboratory table.

FIG. 12 is a perspective front-view drawing illustrating an exemplary laboratory protective apparatus in a fully extended position from under a laboratory table.

FIG. 13 is a perspective front-view drawing illustrating an exemplary laboratory protective apparatus positioned on a laboratory table.

FIG. 14 is a perspective front-view drawing illustrating an exemplary laboratory protective apparatus extended from a laboratory table.

FIG. 15 is a perspective front-view drawing illustrating an exemplary laboratory protective apparatus retracted on the side of a laboratory table.

FIG. 16 is a perspective front-view drawing illustrating an exemplary laboratory protective apparatus positioned on a laboratory table.

FIG. 17 is a perspective front-view drawing illustrating an exemplary laboratory protective apparatus mounted on a laboratory wall.

FIG. 18 is a perspective front-view drawing illustrating an exemplary laboratory protective apparatus in an extended position from a laboratory wall.

FIG. 19 is a perspective front-view drawing illustrating an exemplary laboratory protective apparatus mounted on a laboratory wall.

FIG. 20 is a perspective front-view drawing illustrating an exemplary laboratory protective apparatus in a partially extended position from a laboratory wall.

FIG. 21 is a perspective front-view drawing illustrating an exemplary laboratory protective apparatus in fully extended position from a laboratory wall.

FIG. 22 is a perspective front-view drawing illustrating an exemplary transparent shield.

FIG. 23 is a perspective front-view drawing illustrating an exemplary transparent shield.

FIG. 24 is a block diagram illustrating an exemplary method of using an exemplary laboratory protective apparatus.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides a versatile laboratory protective apparatus that can be attached underneath wall cabinets, underneath a countertop in a laboratory, a wall, or any other fixture and can be deployed as needed. The versatile laboratory protective apparatus will not only save valuable laboratory space, but will act as (1) a shield to protect face and eyes from any splashing of materials, (2) a holder for posters, pictures, graphs or other materials for presentation in the laboratory, (3) a writing board, (4) a light source, (5) a ruler, (6) a magnifying lens, (7) a safe light filter, (8) a disinfection apparatus, (9) a calculator holder, (10) a holder for instrument gauges, for example, humidity and/or temperature, (11) a pen holder, or a combination thereof.

The versatile laboratory protective apparatus does not occupy any space on the laboratory countertop as current safety shields. The versatile laboratory protective apparatus is inexpensive to manufacture and easy to install. Further, important laboratory items, for example, lights, temperature and humidity gauges, calculators, pen holders, magnifying lenses, rulers, and the like can be attached to the protective apparatus and be within easy viewing distance of the laboratory worker. If a safe light environment is needed, the protective apparatus can be constructed with the appropriate safe light material to effective block damaging light from entering into and/or exiting from the work area. If disinfection of the work bench is required, an ultraviolet light may be included in the versatile laboratory protective apparatus.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein. The referenced items are provided solely for their disclosure prior to the filing date of the present application. Nothing herein is to be construed as an admission that the present invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993, The American Heritage Dictionary of the English Language, Houghton Mifflin, Boston Mass., 1981, and Hawley's Condensed Chemical Dictionary, 14^{th} edition, Wiley Europe, 2002.

The following explanations of certain terms are meant to be illustrative rather than exhaustive. These terms have their ordinary meanings given by usage in the art and in addition include the following explanations.

As used herein, the term “about” refers to a variation of 10 percent of the value specified; for example about 50 percent carries a variation from 45 to 55 percent.

As used herein, the term “and/or” refers to any one of the items, any combination of the items, or all of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the terms “include,” “for example,” “such as,” and the like are used illustratively and are not intended to limit the present invention.

As used herein, the term “laboratory” refers to any facility where any scientific, engineering, medical, dental, clinical, biological, microbiological, serological, chemical, immune-hematological, hematological, biophysical, cytological, pathological, and similar work takes place.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element which they describe, as the various elements may be oriented differently in various applications.

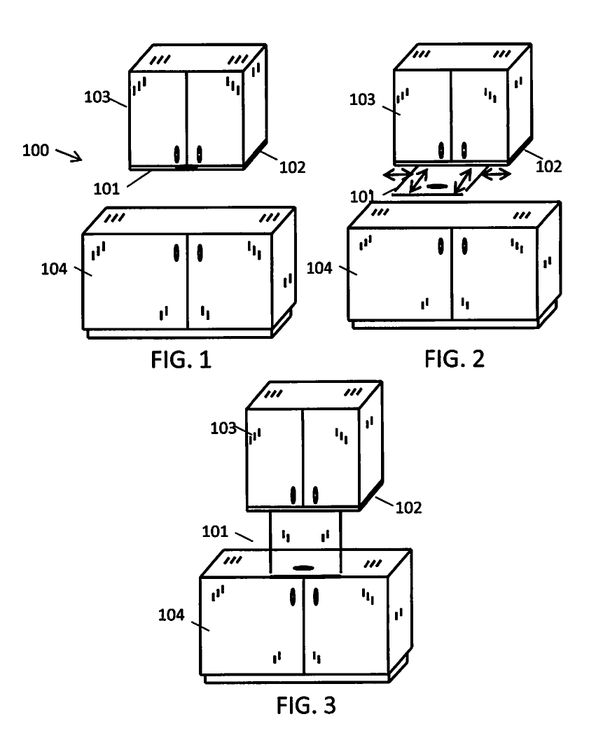

FIG. 1 is a perspective front-view drawing illustrating an exemplary laboratory protective apparatus 100 retracted under a laboratory cabinet. The versatile laboratory protective apparatus 100 includes a retractable transparent shield 101 and the supporting member 102. The supporting member 102 is attached to the bottom of the upper laboratory cabinet 103, which is above the lower laboratory cabinet 104.

The supporting member 102 may include two tracks connected to the bottom of the upper laboratory cabinet 103. These two tracks allow the transparent shield 101 to extend outward from the tracks (FIG. 2) and then rotate down to cover the surface of the lower laboratory cabinet 104 (FIG. 3). The transparent shield 101 can be positioned at any angle based on the user's need.

The supporting member 102 may also include a track bar fixed underneath the upper laboratory cabinet 103, on which is slidably mounted a slider member having a pair of shaft bars planted on each side thereof to which are rotatably attached a pair of C-shaped clips used to hold the transparent shield 101. A suitable supporting member 102 may include the device as described in U.S. Pat. No. 4,672,842. Another suitable supporting member 102 may include a cantilever device as described in U.S. Pat. No. 4,281,874. Yet another suitable supporting member 102 may include the adjustable cantilever device as described in U.S. Pat. No. 3,858,836. Other suitable supporting members 102 may be found in U.S. Pat. Nos. 4,043,701, 4,543,021, 4,981,086, 5,398,176, 5,012,852, and 6,390,741. Yet another suitable supporting member 102 may include Velcro connectors.

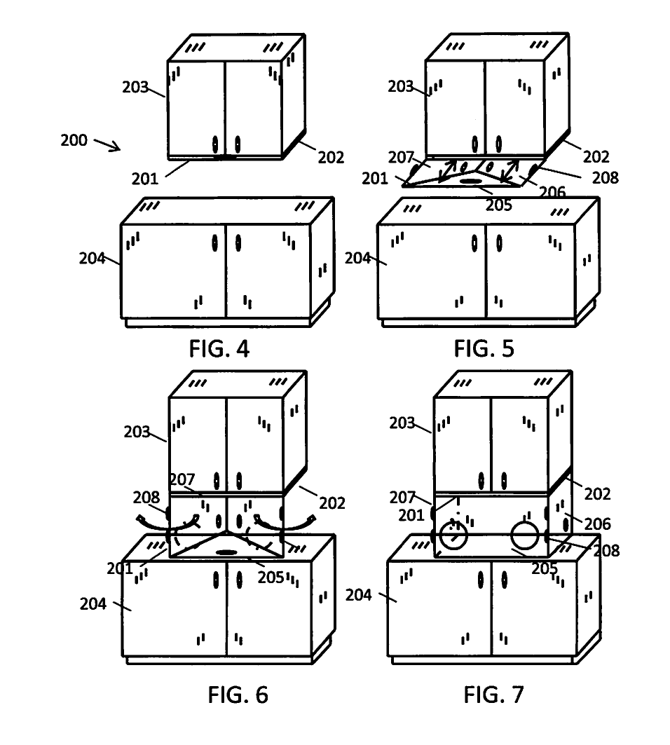

FIG. 4 is a perspective front-view drawing illustrating an exemplary laboratory protective apparatus 200 retracted under a laboratory cabinet. The versatile laboratory protective apparatus 200 includes a retractable transparent shield 201 and the supporting member 202. The supporting member 202 is attached to the bottom of the upper laboratory cabinet 203, which is above the lower laboratory cabinet 204. The transparent shield 201 includes a front transparent shield 205, a right-side transparent shield 206, and a left-side transparent shield 207. The right-side transparent shield 206 and the left-side transparent shield 207 are connected to the front transparent shield 205 with hinges 208.

The supporting member 202 may include two tracks connected to the bottom of the upper laboratory cabinet 203. These two tracks allow the transparent shield 201 to extend outward from the tracks (FIG. 5), rotate down to cover the surface of the lower laboratory cabinet 204 (FIG. 6), and then extend the right-side transparent shield 206 and the left-side transparent shield 207 (FIG. 7).

The supporting member 202 may also include a track bar fixed underneath the upper laboratory cabinet 203, on which is slidably mounted a slider member having a pair of shaft bars planted on each side thereof to which are rotatably attached a pair of C-shaped clips used to hold the transparent shield 201. A suitable supporting member 202 may include the device as described in U.S. Pat. No. 4,672,842. Another suitable supporting member 202 may include a cantilever device as described in U.S. Pat. No. 4,281,874. Yet another suitable supporting member 202 may include the adjustable cantilever device as described in U.S. Pat. No. 3,858,836. Other suitable supporting members 202 may be found in U.S. Pat. Nos. 4,043,701, 4,543,021, 4,981,086, 5,398,176, 5,012,852, and 6,390,741. Yet another suitable supporting member 202 may include Velcro connectors.

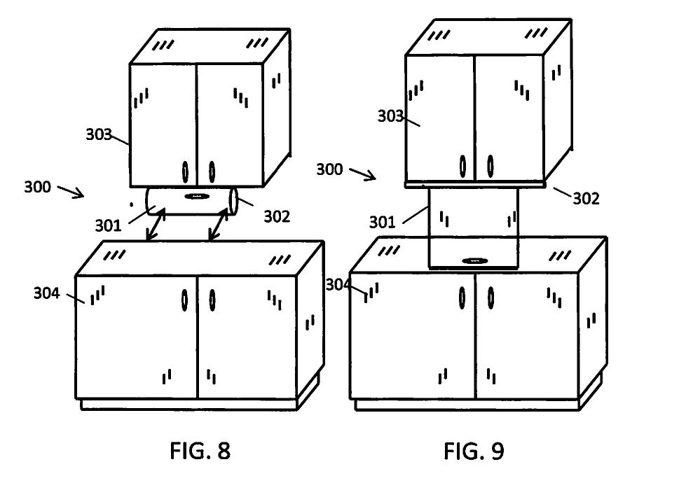

FIG. 8 is a perspective front-view drawing illustrating an exemplary laboratory protective apparatus 300 retracted under a laboratory cabinet. The versatile laboratory protective apparatus 300 includes a retractable transparent shield 301 and the supporting member 302. The supporting member 302 is attached to the bottom of the upper laboratory cabinet 303, which is above the lower laboratory cabinet 304. The retractable transparent shield 301 is in a roll form and is contained within the supporting member 302.

The roll-up mechanism in the supporting member 302 allows the transparent shield 301 to be pulled out and down to cover the surface of the lower laboratory cabinet 304 (FIG. 9). The roll up mechanism may be one of many roll-up mechanisms that are well known to one of skill in the art.

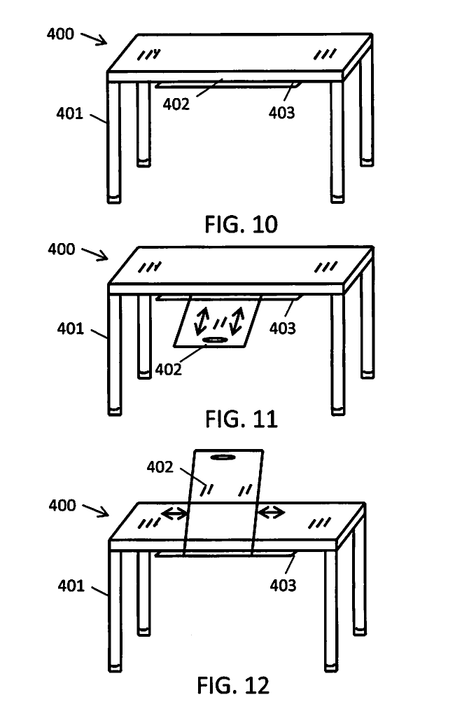

FIG. 10 is a perspective front-view drawing illustrating an exemplary laboratory protective apparatus 400 retracted under a laboratory table 401. The versatile laboratory protective apparatus 400 includes a retractable transparent shield 402 and the supporting member 403. The supporting member 403 is attached to the bottom of the laboratory table 401.

The supporting member 403 may include two tracks connected to the bottom of the laboratory table 401. These two tracks allow the transparent shield 402 to extend outward from the tracks (FIG. 11), rotate upward to cover the top surface of the transparent shield 402 (FIG. 12).

The supporting member 403 may also include a track bar fixed underneath the laboratory table 401, on which is slidably mounted a slider member having a pair of shaft bars planted on each side thereof to which are rotatably attached a pair of C-shaped clips used to hold the transparent shield 402. A suitable supporting member 403 may include the device as described in U.S. Pat. No. 4,672,842. Another suitable supporting member 403 may include a cantilever device as described in U.S. Pat. No. 4,281,874. Yet another suitable supporting member 403 may include the adjustable cantilever device as described in U.S. Pat. No. 3,858,836. Other suitable supporting members 403 may be found in U.S. Pat. Nos. 4,043,701, 4,543,021, 4,981,086, 5,398,176, 5,012,852, and 6,390,741. Yet another suitable supporting member 403 may include Velcro connectors.

The transparent shield 402 an optional right-side transparent shield (not shown), and an optional left-side transparent shield (not shown). The optional right-side transparent shield and the optional left-side transparent shield are connected to the transparent shield 402 with hinges (not shown). Other embodiments may use a bench, laboratory cabinet bench top, or countertop in place of the laboratory table 401.

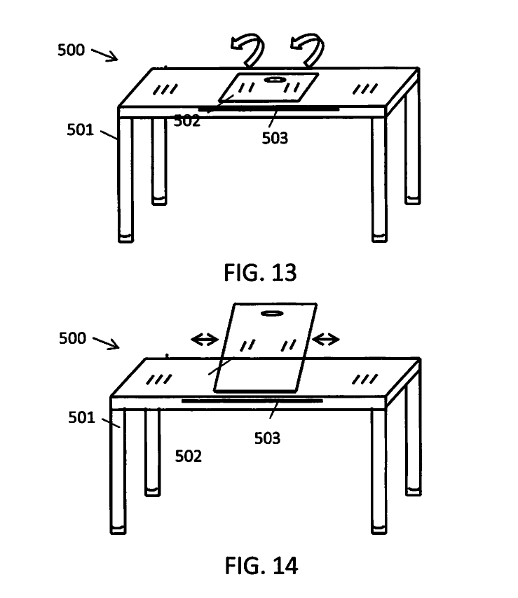

FIG. 13 is a perspective front-view drawing illustrating an exemplary laboratory protective apparatus 500 positioned on a laboratory table 501. The versatile laboratory protective apparatus 500 includes a retractable transparent shield 502 and the supporting member 503. The supporting member 503 is attached to the bottom of the laboratory table 501.

The supporting member 503 may include a hinge connected to the bottom of the laboratory table 501. The hinge allows the transparent shield 502 to rotate upward to cover the top surface of the laboratory table 501 (FIG. 14).

The transparent shield 502 an optional right-side transparent shield (not shown), and an optional left-side transparent shield (not shown). The optional right-side transparent shield and the optional left-side transparent shield are connected to the transparent shield 502 with hinges (not shown). The transparent shield 502 can be positioned at any angle based on the user's need.

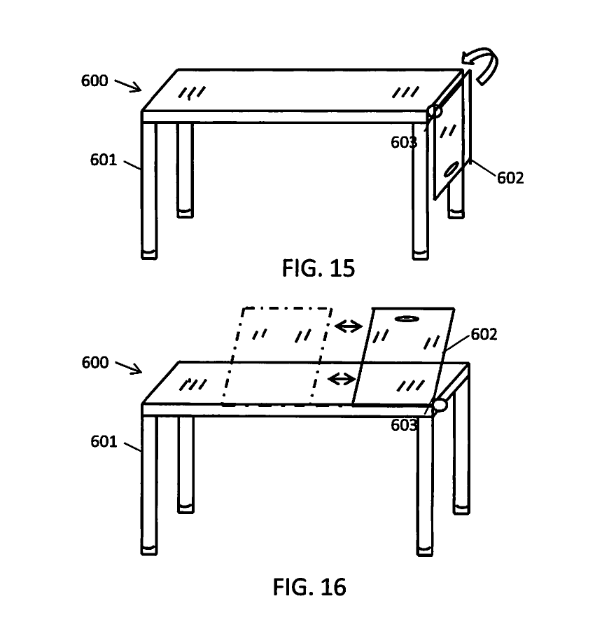

FIG. 15 is a perspective front-view drawing illustrating an exemplary laboratory protective apparatus 600 retracted on the side of a laboratory table 601. The versatile laboratory protective apparatus 600 includes a retractable transparent shield 602 and the supporting member 603. The supporting member 603 is attached to the side of the laboratory table 601.

The supporting member 603 may include a hinge with a pivot connected to the bottom of the laboratory table 601. The hinge with a pivot allows the transparent shield 602 to rotate upward to cover the top surface of the laboratory table 601 (FIG. 16). The transparent shield 602 may also be moved horizontally based on the user's need.

The transparent shield 602 an optional right-side transparent shield (not shown), and an optional left-side transparent shield (not shown). The optional right-side transparent shield and the optional left-side transparent shield are connected to the transparent shield 602 with hinges (not shown).

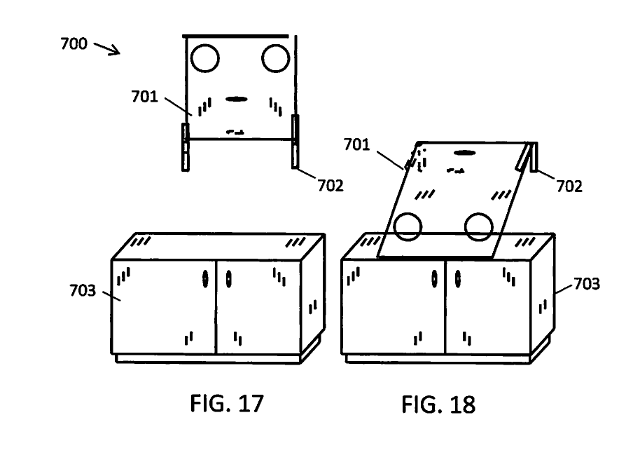

FIG. 17 is a perspective front-view drawing illustrating an exemplary laboratory protective apparatus 700 mounted on a laboratory wall.

The versatile laboratory protective apparatus 700 includes a retractable transparent shield 701 and the supporting member 702. The transparent shield 701 includes one or two transparent shields folded on to each other. The supporting member 702 is attached to the laboratory wall above the laboratory cabinet 703.

The supporting member 702 may include a cantilever device, as described in U.S. Pat. No. 4,281,874, connected to the laboratory wall. This cantilever device allows the transparent shield 701 to extend outward from the wall and rotate down to cover the surface of the laboratory cabinet 703 (FIG. 18).

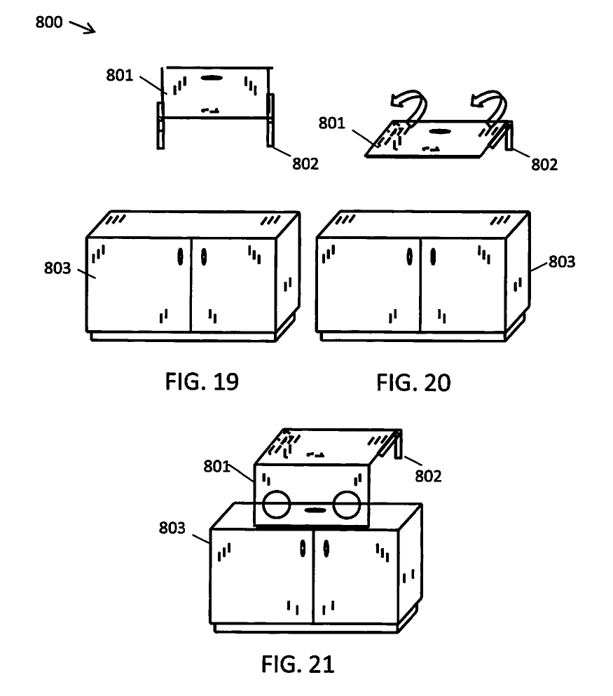

FIG. 19 is a perspective front-view drawing illustrating an exemplary laboratory protective apparatus 800 mounted on a laboratory wall.

The versatile laboratory protective apparatus 800 includes a retractable transparent shield 801 and the supporting member 802. The transparent shield 801 includes two transparent shields folded on to each other. In other embodiments, transparent shield 801 includes more than two transparent shields folded on to each other. The supporting member 802 is attached to the laboratory wall above the laboratory cabinet 803.

The supporting member 802 may include a cantilever device, as described in U.S. Pat. No. 4,281,874, connected to the laboratory wall. This cantilever device allows the transparent shield 801 to extend outward from the wall (FIG. 20) and then positioned based upon the user's needs, or unfolded and rotated down to cover the surface of the laboratory cabinet 803 (FIG. 21).

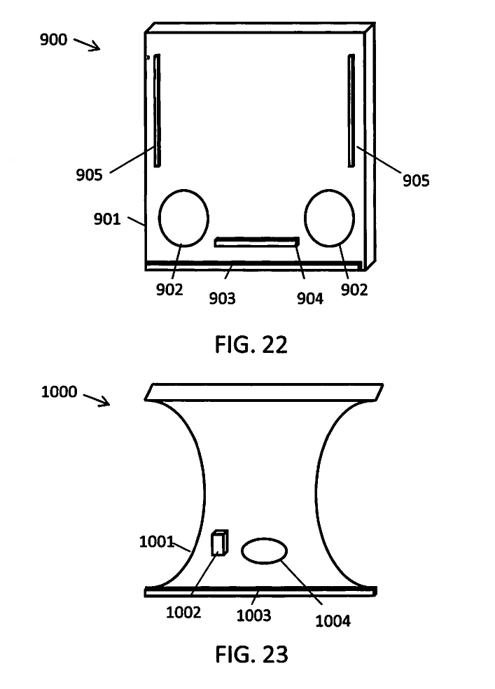

FIG. 22 is a perspective front-view drawing illustrating an exemplary transparent shield 900 that may be used in any or all embodiments described herein. The transparent shield 900 may include a rigid protective transparent sheet 901, two apertures 902, a tray 903 to hold writing instruments and/or poster boards, a ruler 904, and two lights 905.

FIG. 23 is a perspective front-view drawing illustrating an exemplary transparent shield 1000 that may be used in any or all embodiments described herein. The transparent shield 1000 may include a rigid protective transparent sheet 1001 with curved sides, a temperature and/or humidity gauge 1002, a tray 1003 to hold writing instruments and/or poster boards, and a magnifying glass 1004 with different shapes and sizes. All of the accessories, for example, gauge, calculator, ruler, light, and the like may be used in state of the art flat version on the surface of the shield.

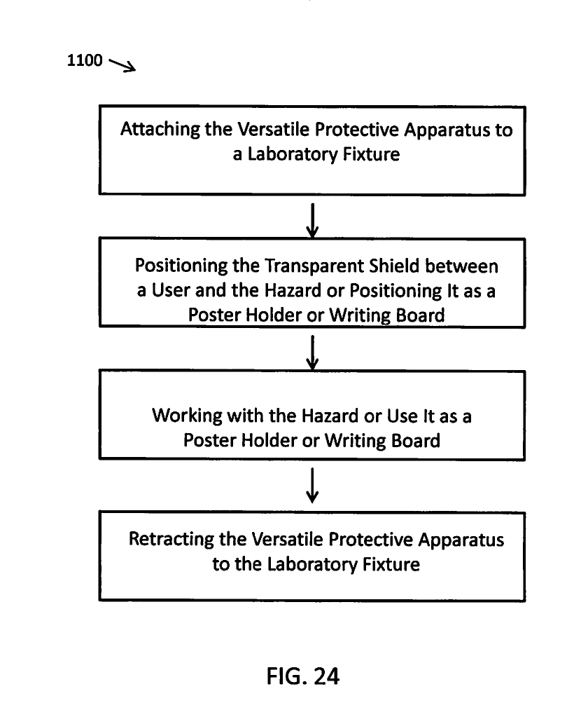

FIG. 24 is a block diagram illustrating an exemplary method 1100 of using an exemplary laboratory protective apparatus. The method 1100 includes; attaching the versatile laboratory protective apparatus to a laboratory fixture; positioning the one or more transparent shields between a user and the hazard or position it as a poster holder or writing board; working with the hazard or using it as a poster holder or writing board, and retracting the versatile laboratory protective apparatus to the laboratory fixture.

In FIGS. 1-23, as described herein, the protective shields extend perpendicular relative to the fixtures. In one or more other embodiments, the protective shields, as described herein, may be attached to one or more supporting members that allow each protective shield to rotate about the fixture. In one or more other embodiments, the protective shields, as described herein, may be attached to one or more supporting members that allow each protective shield to extend from the fixture and to rotate about the fixture.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed then several other steps are performed shall be taken to mean that the first step is performed before any of the other steps, but the other steps may be performed in any sequence unless a sequence is further specified within the other steps. For example, claim elements that recite “first A, then B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, the claims referred to above including but not limited to any original claims.

What is claimed is:

1. A versatile laboratory protective apparatus comprising:
one or more transparent shields each having an upper surface, a lower surface, a front edge, a back edge, a right-side edge, and a left-side edge; and
one or more supporting members each independently attaching the one or more transparent shields to one or more pieces of furniture, one or more fixtures, or one or more walls,
wherein the one or more transparent shields and the one or more supporting members are assembled in a manner such that the one or more transparent shields can be positioned down or positioned up from the one or more pieces of furniture, one or more fixtures, or one or more walls, and positioned between a user and a source of one or more bio-hazardous materials, chemicals, electromagnetic radiation, wood chips, metal chips, or combinations thereof.

2. The versatile laboratory protective apparatus of claim 1, wherein the one or more transparent shields each independently comprise one or more rigid shatter-resistant transparent sheet materials.

3. The versatile laboratory protective apparatus of claim 1, wherein the one or more transparent shields each independently comprise polyacrylate, polymethacrylate, polycarbonate, polyolefin, ethylvinyl alcohol, polyester, co-polymerized polyester, polyamide, polyethylene terephthalate, polyurethane, polyethylene, polyvinylchloride film, polybutylene terephthalate, or combinations thereof.

4. The versatile laboratory protective apparatus of claim 1, wherein the one or more transparent shields each independently further comprises one or more lights, one or more rulers, one or more magnifying lens, one or more protractors, one or more calculators, one or more watches, one or more timers, one or more temperature gauges, one or more vacuum pumps, one or more humidity gauges, one or more trays, one or more writing surfaces, one or more writing pads, one or more paper holding devices, one or more poster holding devices, or a combination thereof.

5. The versatile laboratory protective apparatus of claim 4, wherein the one or more lights, one or more rulers, one or more magnifying lens, one or more protractors, one or more calculators, one or more watches, one or more timers, one or more temperature gauges, one or more vacuum pumps, one or more humidity gauges, one or more trays, one or more writing surfaces, one or more writing pads, one or more paper holding devices, one or more poster holding devices, or a combination thereof are each independently located on the upper surface of the one or more transparent shields, the lower surface of the one or more transparent shields, the front edge of the one or more transparent shields, the back edge of the one or more transparent shields, the right-side edge of the one or more transparent shields, the left-side edge of the one or more transparent shields, or a combination thereof.

6. The versatile laboratory protective apparatus of claim 1, wherein the one or more pieces of furniture, one or more fixtures, or one or more walls, each independently comprise a work bench having an upper surface and a lower surface, a cabinet having an upper surface and a lower surface, a shelf having an upper surface and a lower surface, a wall having an outer surface, a floor stand, a chair, a bed having an upper surface and a lower surface, a pipe, or a combination thereof.

7. The versatile laboratory protective apparatus of claim 1, wherein the one or more transparent shields each independently further comprises one or more front shields, one or more left-side shields, one or more right side shields, or a combination thereof.

8. The versatile laboratory protective apparatus of claim 1, wherein the one or more supporting members each comprise one or more drawer slide devices, one or more hinge devices, one or more adjustable arm devices, one or more hook-and-loop fastener devices, one or more cantilever devices, or combinations thereof.

9. The versatile laboratory protective apparatus of claim 1, further comprising a notch into the right edge of the one or more transparent shields and a notch into the left edge of the one or more transparent shields to facilitate access to the source of the one or more bio-hazardous materials, chemicals, electromagnetic radiation, or combinations thereof.

10. The versatile laboratory protective apparatus of claim 1, wherein the positioning of the one or more transparent shields is performed manually, by a machine, or a combination thereof.

11. A versatile laboratory protective apparatus comprising:
one or more transparent shields each having an upper surface, a lower surface, a front edge, a back edge, a right-side edge, and a left-side edge,
wherein the one or more transparent shields each independently comprise one or more rigid shatter-resistant transparent sheet materials; and
one or more supporting members each independently attaching the one or more transparent shields to one or more pieces of laboratory furniture, one or more laboratory fixtures, or one or more laboratory walls,
wherein the one or more pieces of laboratory furniture, one or more laboratory fixtures, or one or more laboratory walls, comprises a work bench having an upper surface and a lower surface, a cabinet having an upper surface and a lower surface, a shelf having an upper surface and a lower surface, a wall having an outer surface, a floor stand, a chair, a bed, a pipe, or a combination thereof, and
wherein the one or more transparent shields and the one or more supporting members are assembled in a manner that the one or more transparent shields can be positioned down or positioned up from the one or more pieces of laboratory furniture, one or more laboratory fixtures, or one or more laboratory walls, and positioned between a user and a source of one or more bio-hazardous materials, chemicals, electromagnetic radiation, wood chips, metal chips, or combinations thereof.

12. The versatile laboratory protective apparatus of claim 11, wherein the one or more transparent shields each independently comprise polyacrylate, polymethacrylate, polycarbonate, polyolefin, ethylvinyl alcohol, polyester, co-polymerized polyester, polyamide, polyethylene terephthalate, polyurethane, polyethylene, polyvinylchloride film, polybutylene terephthalate, or combinations thereof.

13. The versatile laboratory protective apparatus of claim 11, wherein the one or more transparent shields each independently further comprises one or more lights, one or more rulers, one or more magnifying lens, one or more protractors, one or more calculators, one or more watches, one or more timers, one or more temperature gauges, one or more humidity gauges, one or more vacuum pumps, one or more trays, one or more writing surfaces, one or more writing pads, one or more paper holding devices, one or more poster holding devices, or a combination thereof.

14. The versatile laboratory protective apparatus of claim 11, wherein the one or more lights comprise one or more fluorescent lights, one or more ultra-violet lights, one or more infrared lights, or a combination thereof.

15. The versatile laboratory protective apparatus of claim 11, wherein the one or more supporting members each independently attach the one or more transparent shields to the lower surface of the work bench.

16. The versatile laboratory protective apparatus of claim 11, wherein the one or more supporting members each independently attach the one or more transparent shields to the lower surface of the cabinet.

17. The versatile laboratory protective apparatus of claim 11, further comprising a notch into the right edge of the one or more transparent shields and a notch into the left edge of the one or more transparent shields to facilitate access to the source of the one or more bio-hazardous materials, chemicals, electromagnetic radiation, or combinations thereof.

18. The versatile laboratory protective apparatus of claim 11, wherein the one or more transparent shields each independently further comprises one or more left-side shields, one or more right side shields, or a combination thereof.

19. The versatile laboratory protective apparatus of claim 18, wherein the one or more left-side shields, the one or more right side shields, or a combination thereof, may each independently comprise an aperture, a protective glove, or a combination thereof.

20. A method of shielding personnel from one or more bio-hazardous materials, chemicals, electromagnetic radiation, or combinations thereof, the method comprising:
attaching a laboratory protective apparatus to one or more pieces of furniture, one or more fixtures, or one or more walls, wherein the versatile laboratory protective apparatus comprises;
one or more transparent shields each having an upper surface, a lower surface, a front edge, a back edge, a right-side edge, and a left-side edge; and
one or more supporting members each independently attaching the one or more transparent shields to the one or more pieces of furniture, one or more fixtures, or one or more walls, wherein the one or more transparent shields and the one or more supporting members are assembled in a manner such that the one or more transparent shields can be positioned down or positioned up from the one or more pieces of furniture, one or more fixtures, or one or more walls, and positioned between a user and a source of one or more bio-hazardous materials, chemicals, electromagnetic radiation, or combinations thereof;
positioning the one or more transparent shields between a user and a source of one or more bio-hazardous materials, chemicals, electromagnetic radiation, wood chips, metal chips, or combinations thereof; and
working with the source of one or more bio-hazardous materials, chemicals, electromagnetic radiation, or combinations thereof.
